(19) United States
(12) Patent Application Publication
(10) Pub. No.: US 2012/0079303 A1
(43) Pub. Date: Mar. 29, 2012

(54) METHOD AND APPARATUS FOR REDUCING POWER CONSUMPTION IN A PROCESSOR BY POWERING DOWN AN INSTRUCTION FETCH UNIT

(76) Inventor: Venkateswara R. Madduri, Austin, TX (US)

(21) Appl. No.: 12/890,561

(22) Filed: Sep. 24, 2010

(51) Int. Cl. G06F 1/32

(52) U.S. Cl. 713/324

(57) ABSTRACT

An apparatus and method are described for reducing power consumption in a processor by powering down an instruction fetch unit. For example, one embodiment of a method comprises: detecting a branch, the branch having addressing information associated therewith; comparing the addressing information with entries in an instruction prefetch buffer to determine whether an executable instruction loop exists within the prefetch buffer; wherein if an instruction loop is detected as a result of the comparison, then powering down an instruction fetch unit and/or components thereof; and streaming instructions directly from the prefetch buffer until a clearing condition is detected

### BACKGROUND

1. Field of the Invention

This invention relates generally to the field of computer processors. More particularly, the invention relates to an apparatus and method for detecting instruction loops and other instruction groupings within a buffer and responsively powering down a fetch unit.

2. Description of the Related Art

Many modern microprocessors have large instruction pipelines that facilitate high speed operation. “Fetched” program instructions enter the pipeline, undergo operations such as decoding and executing in intermediate stages of the pipeline, and are “retired” at the end of the pipeline. When the pipeline receives a valid instruction each clock cycle, the pipeline remains full and performance is good. When valid instructions are not received each cycle, the pipeline does not remain full, and performance can suffer. For example, performance problems can result from branch instructions in program code. If a branch instruction is encountered in the program and the processing branches to the target address, a portion of the instruction pipeline may have to be flushed, resulting in a performance penalty.

Branch Target Buffers (BTB) have been devised to lessen the impact of branch instructions on pipeline efficiency. A discussion of BTBs can be found in David A. Patterson & John L. Hennessy, Computer Architecture A Quantitative Approach 271-275 (2d ed. 1990). A typical BTB application is also shown in FIG. 1 which illustrates a BTB 110 coupled to instruction pointer (IP) 118, and processor pipeline 120. Also included in FIG. 1 is cache 130 and fetch buffer 132. The location of the next instruction to be fetched is specified by IP 118. As execution proceeds in sequential order in a program, IP 118 increments each cycle. The output of IP 118 drives port 134 of cache 130 and specifies the address from which the next instruction is to be fetched. Cache 130 provides the instruction to fetch buffer 132, which in turn provides the instruction to processor pipeline 120.

When instructions are received by pipeline 120, they proceed through several stages shown as fetch stage 122, decode stage 124, intermediate stages 126 (e.g., instruction execution stages), and retire stage 128. Information on whether a branch instruction results in a taken branch is sometimes not available until a later pipeline stage, such as retire stage 128. When BTB 110 is not present and a branch is taken, fetch buffer 132 and the portion of instruction pipeline 120 following the branch instruction hold instructions from the wrong execution path. The invalid instructions in processor pipeline 120 and fetch buffer 132 are flushed, and IP 118 is written with the branch target address. A performance penalty results, in part because the processor waits while fetch buffer 132 and instruction pipeline 120 are filled with instructions starting at the branch target address.

Branch target buffers (BTBs) lessen the performance impact of taken branches. BTB 110 includes records 111, each having a branch address (BA) field 112 and a target address (TA) field 114. TA field 114 holds the branch target address for the branch instruction located at the address specified by the corresponding BA field 112. When a branch instruction is encountered by processor pipeline 120, the BA fields 112 of records 111 are searched for a record matching the address of the branch instruction. If found, IP 118 is changed to the value of the TA field 114 corresponding to the found BA field 112. As a result, instructions are next fetched starting at the branch target address.

Conserving power in the processor pipeline is important, particularly for laptops and other mobile devices which run on battery power. As such, it would be beneficial to power down certain portions of the processor pipeline such as the instruction fetch circuitry and instruction cache when groups of repetitive instructions (e.g., nested loops) are located within the fetch buffer. Accordingly, new techniques for detecting conditions under which fetch circuitry or portions thereof may be powered down would be beneficial.

### BRIEF DESCRIPTION OF THE DRAWINGS

A better understanding of the present invention can be obtained from the following detailed description in conjunction with the following drawings, in which:

FIG. 1 illustrates a prior art processor pipeline which employs a branch target buffer for performing branch target prefetch.

FIG. 2 illustrates one embodiment of a processor architecture which includes a loop stream detector for streaming instructions from a prefetch buffer and responsively powering down portions of a processor pipeline.

FIG. 3 illustrates one embodiment of a method for detecting groups of repetitive instructions and responsively powering down portions of a processor pipeline.

FIG. 4 illustrates a pipeline diagram illustrating one embodiment of a loop stream detector becoming engaged.

FIG. 5 illustrates fields employed in one embodiment of a prefetch buffer used to engage a loop stream detector.

FIG. 6 illustrates fields employed in another embodiment of the prefetch buffer used to engage the loop stream detector.

FIG. 7 illustrates exemplary program code which includes nested instruction sequences.

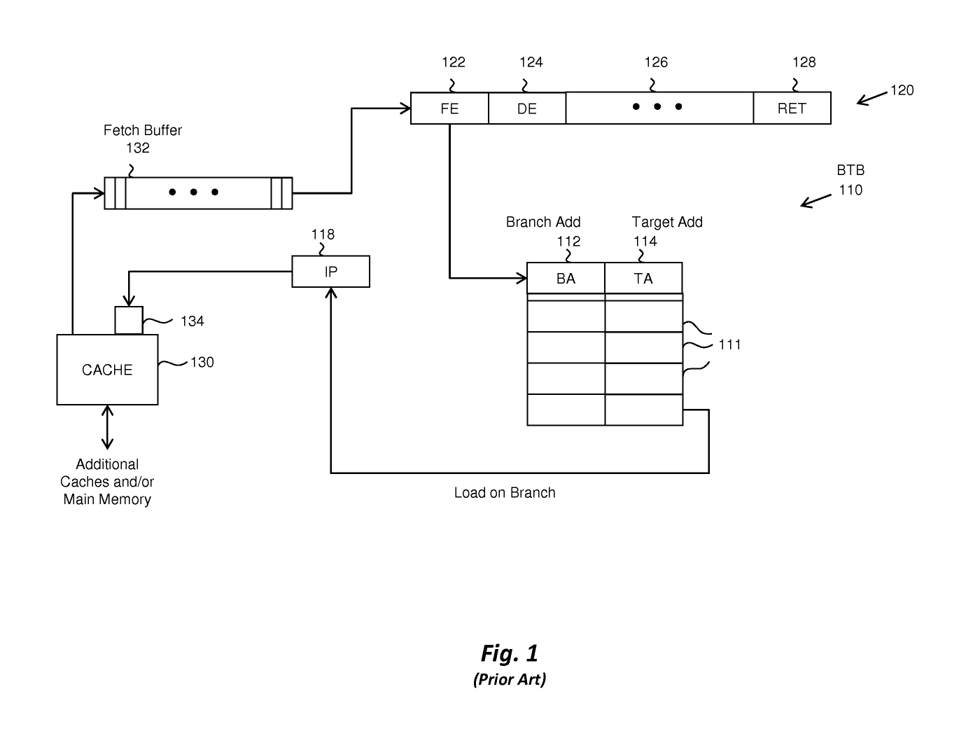

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

One embodiment of the invention reduces the dynamic power of the CPU core when it is executing repetitive groups of instructions such as nested loops and/or nested branches. For example, when instruction groups predicted by a branch predictor are detected within a prefetch buffer, one embodiment of the invention powers down the fetch unit and associated instruction fetch circuitry (or portions thereof) to conserve power. The instructions are then streamed directly from the prefetch buffer until additional instructions are needed, at which time the instruction fetch unit is powered on. Embodiments of the invention may operate in both a single threaded or multi-threaded environment. In one embodiment, in a single threaded environment, all of the prefetch buffer entries are allocated to a single thread whereas in a multi-threaded environment, the prefetch buffer entries are equally split between the multiple threads.

One particular embodiment comprises a loop stream detector (LSD) with a prefetch buffer for detecting repetitive groups of instructions. The loop stream detector prefetch buffer may be 6-entry deep in multithreaded mode (3 for Thread-0 and 3 for Thread-1) and 3-entry deep in single threaded mode. Alternatively, all 6 entries may be used for a single thread in single-threaded mode. In one embodiment, in single threaded mode, the number of entries can be configured to be either 3 or 6 in the prefetch buffer.

In one embodiment, the loop stream detector prefetch buffer stores branch information such as current linear instruction pointer (CLIP), offset, and branch target address read pointer of the prefetch buffer for each branch target buffer (BTB) predicted branch that is written into the prefetch buffer. When the BTB predicts a branch, the CLIP and offset of the branch may be compared against the entries in the prefetch buffer to determine if this branch already resides in the prefetch buffer. If there is a match, the fetch unit, or portions thereof such as the instruction cache, are shut down the instructions are streamed from the prefetch buffer until a clearing condition is encountered (e.g., such as a mispredicted branch). If there are BTB predicted branches within the instruction loop in the prefetch buffer these are also streamed from the prefetch buffer. In one embodiment, the loop stream detector is activated for direct and conditional branches but not for inserted flows, and return/call instructions.

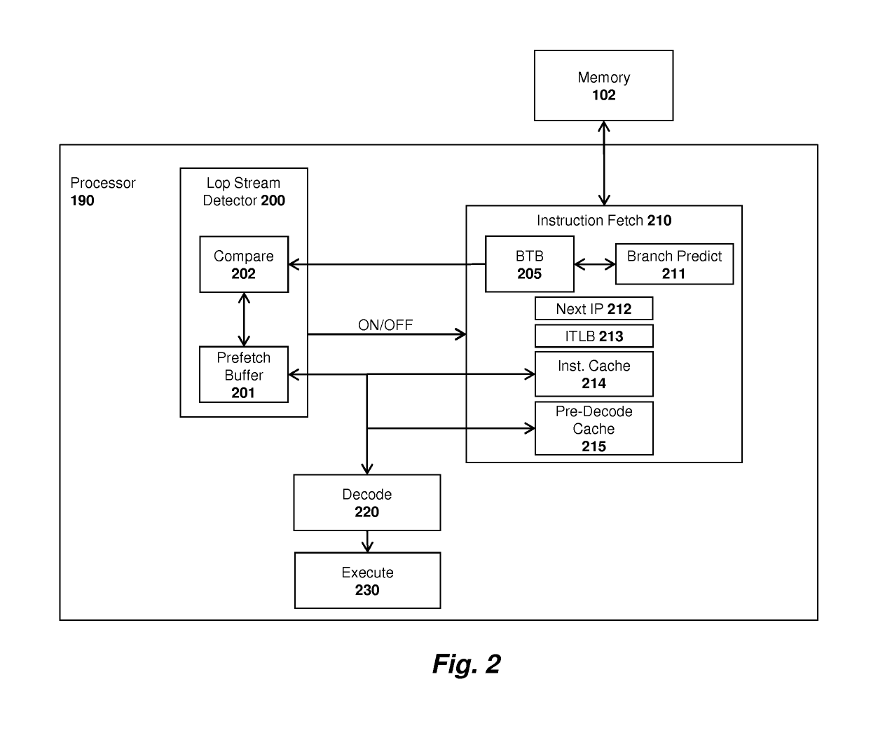

One embodiment of a processor architecture for powering down a fetch unit (and/or other circuitry) upon detecting nested loops, branches, and other repetitive instruction groupings, within a prefetch buffer is illustrated in FIG. 2. As illustrated, this embodiment includes a loop stream detector unit 200 for performing the various functions described herein. In particular, the loop stream detector 200 includes comparison circuitry 202 for comparing branches predicted by a branch target buffer (BTB) with entries in a prefetch buffer 201. As previously mentioned, in one embodiment of the invention, the loop stream detector 200 responsively powers down the instruction fetch unit 210 (or portions thereof) if a match is detected within the prefetch buffer (as indicated by the ON/OFF line in FIG. 2).

Various well known components of the instruction fetch unit 210 may be powered down in response to signals from the loop stream detector including a branch prediction unit 211, a next instruction pointer 212, an instruction translation look-aside buffer (ITLB) an instruction cache 214 and/or a pre-decode cache 215, thereby conserving a significant amount of power if repetitive instruction groups are detected within the prefetch buffer. Instructions are then streamed directly from the prefetch buffer to the remaining stages of the instruction pipeline including, by way of example and not limitation, a decode stage 220 and an execute stage 230.

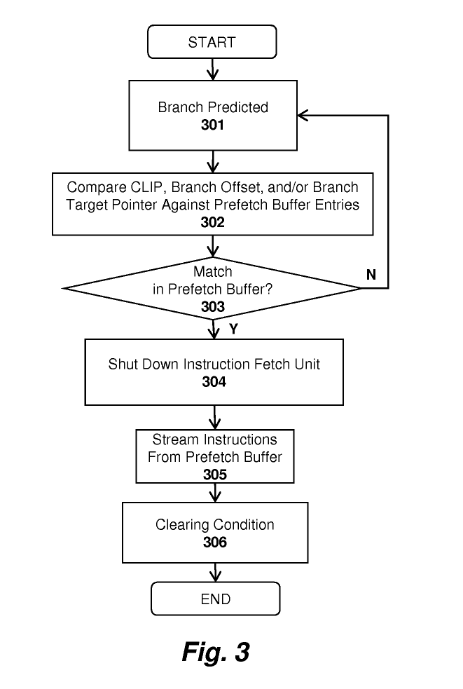

FIG. 3 illustrates one embodiment of a method for powering down a fetch unit (or portions thereof) in response to detecting groups of instruction (such as nested loops) within an instruction buffer. The method may be implemented using the processor architecture shown in FIG. 2, or on a different processor architecture.

At 301 a branch instruction is predicted and the current linear instruction pointer (CLIP), branch offset, and/or branch target address of the branch instruction is determined. At 302, the CLIP, branch offset, and/or branch target address are compared against entries in the prefetch buffer. In one embodiment, the purpose of the comparison is to determine if a nested loop is stored within the prefetch buffer. If a match is found, determined at 303, then at 304, the instruction fetch unit (and/or individual components thereof) is shut down and, at 305, instructions are streamed directly from the prefetch buffer. Instructions continue to be streamed from the prefetch buffer until a clearing condition occurs at 306 (e.g., such as a mis-predicted branch).

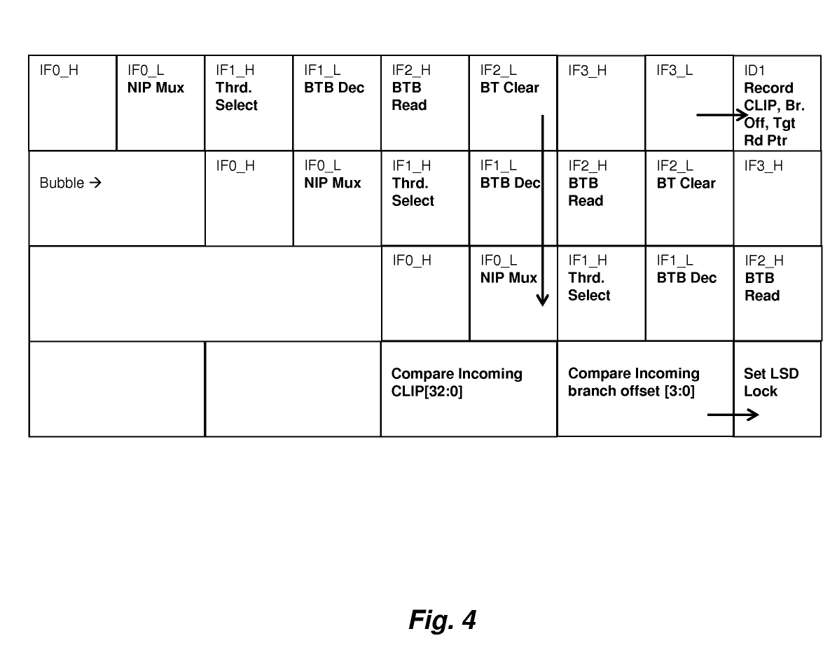

FIG. 4 illustrates how the loop stream detector becomes engaged according to one embodiment of the invention. Specifically, in FIG. 4, the branch is predicted by the predictor in the IF2_L stage within the instruction pipeline (BT Clear) and the next instruction pointer (IP) mux stage is redirected with a bubble to the predicted branch target address. At stage ID1, the CLIP, branch offset, and target read pointer (the pointer identifying the branch target) are recorded within the prefetch buffer. In response to detecting a match of the CLIP, branch offset, and/or target read pointer, the loop stream detector is engaged and, in one embodiment, the fetch unit is disabled. This is illustrated at the bottom of FIG. 4 which shows the CLIP and branch offset being compared, and the loop stream detector lock being set (thereby powering down the fetch unit and/or portions thereof).

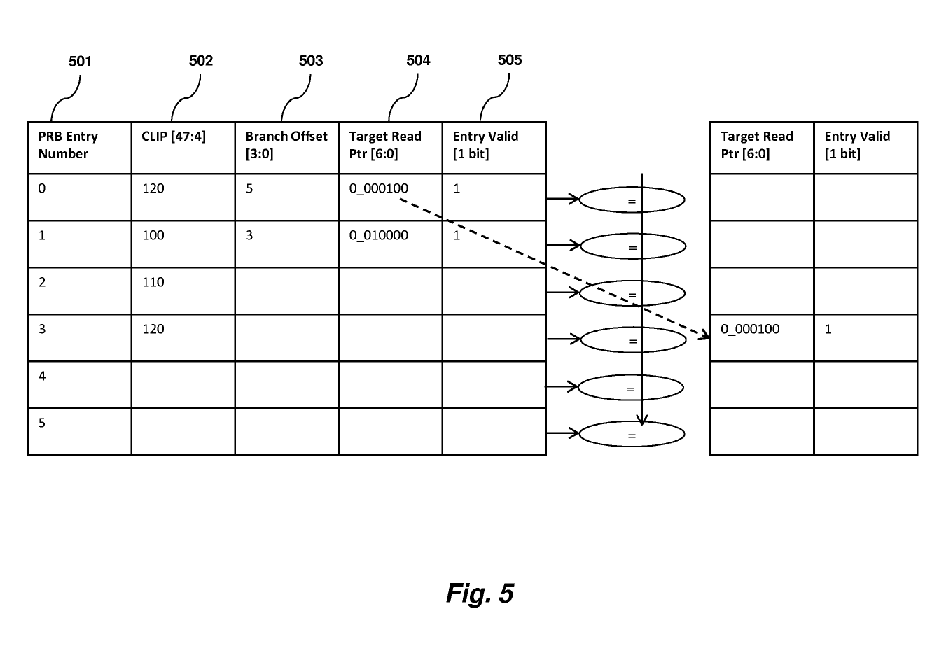

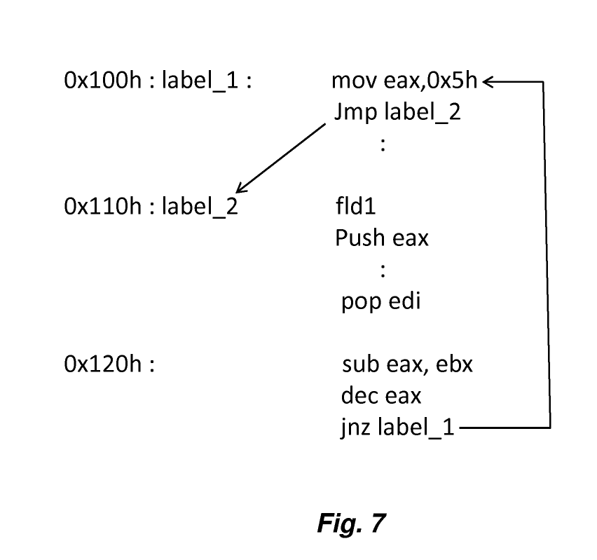

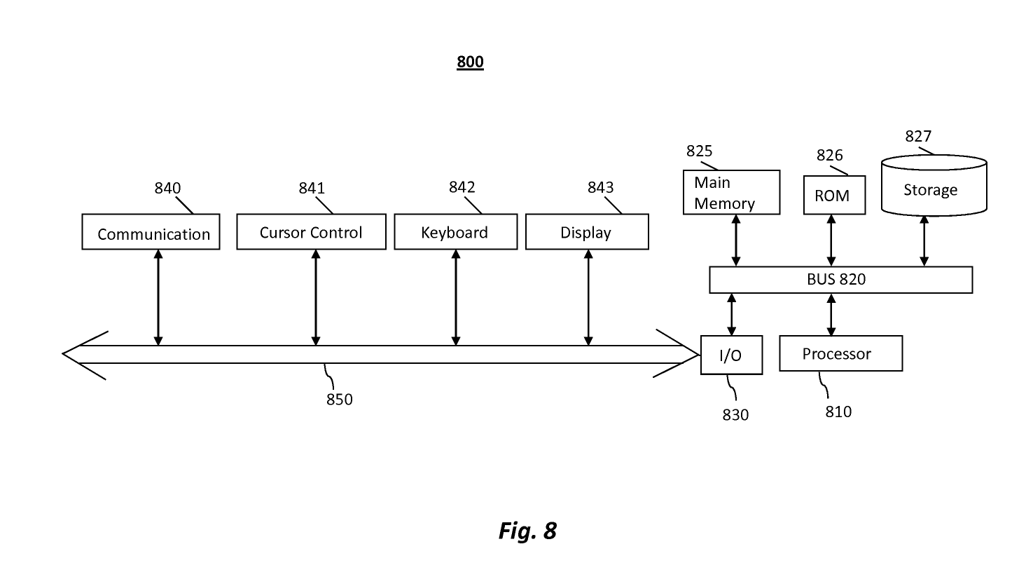

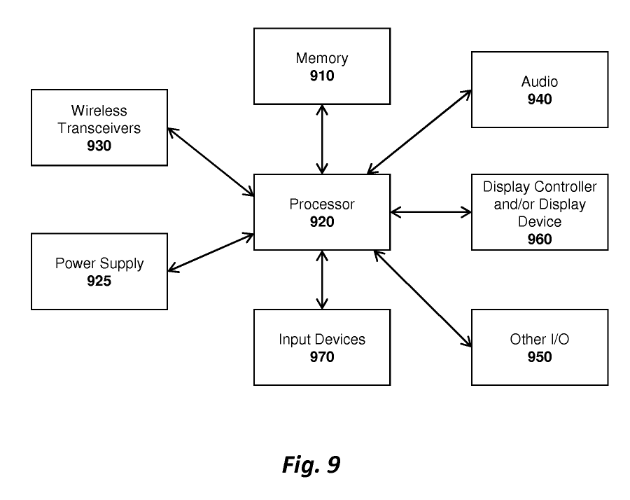

FIG. 5 illustrates the structure of one embodiment of the loop stream detector prefetch buffer with different fields used to engage the loop stream detector and FIG. 7 illustrates an exemplary instruction sequence used for the loop stream detector example of FIG. 5. For convenience, the exemplary instruction sequence is also provided below. The fields used within the LSD prefetch buffer include a prefetch buffer entry number 501 (in this particular example, there are 6 PFB entries, numbered 0-5), a current linear instruction pointer (CLIP) 502, a branch offset field 503, a target read pointer field 504, and an entry valid field 505.

As illustrated, when the loop with the branch at Current Linear Instruction Pointer (CLIP) 0x120h is unrolled by the fetch unit and written into the prefetch buffer, the incoming CLIP and branch offset are compared against the valid CLIP and branch offset fields of each of the PFB entries. In response to the comparison, the valid bit is set at PFB entry 3, as shown. In addition, the PFB entry 3 records the redirection PFB read pointer to enable streaming of the instructions from the PFB. In one embodiment, the following operations are performed:

(1) A branch is predicted.

(2) The CLIP and offset are compared to existing entries in the PFB.

(3) If there is a match against one of the entries in the LSD structure of the PFB (In the illustrated example it is entry 0) the PFB Target Read Ptr field of entry 0 is copied into the entry 3 of the LSD structure and the entry Valid bit is set at the time of the write of the PFB entry. In one embodiment, the PFB entry includes a 16-byte cache line of data and one predecode bit per byte that indicates the end of the macro instruction.

(4) When the PFB read pointer reaches entry 3 it is used to read all the information from entry 3 including the PFB target read pointer and the valid bit.

(5) Based on the valid bit, instead of reading the next sequential PFB entry 4 it is redirected to entry 1 using the target read pointer.

(6) Now the PFB entries are read sequentially from entry 1, entry 2, entry 3.

(7) At entry 3 the PFB valid bit is read and the PFB uses the Target Read Pointer to read the next PFB entry

(8) The steps 6 and 7 are repeated.

In one embodiment, each PFB entry includes a complete 16 byte cache line containing the instructions to be streamed from the PFB. Along with the cache line raw data the predecode bits, and the BTB marker that indicates the last byte of the branch instruction are also stored in the PFB. The predecode bits are stored in the predecode cache 215. There is one bit per byte of the cache line in the predecode cache. This bit indicates the end of the macro instruction. The BTB marker is also one bit per byte that indicates the last byte of the branch instruction. There can be uptol 6 instructions in a 16-byte cacheline that is written into the PFB entry. For a BTB predicted branch instruction the cache line that has the instruction of the branch target is always written into the next sequential entry in the PFB. In one embodiment, there is a 4:1 MUX whose output is used to read the PFB entry. The inputs to the MUX are the (1) PFB read pointer that normally streams instructions from the PFB entry and advances when all the instructions have been streamed from the entry; (2) the branch target PFB read pointer when the branch instruction is streamed from the PFB entry; (3) the PFB read pointer after a clearing condition like a mispredicted branch and this always points to the first PFB entry; and (4) the PFB target read pointer due to the engagement of the LSD.

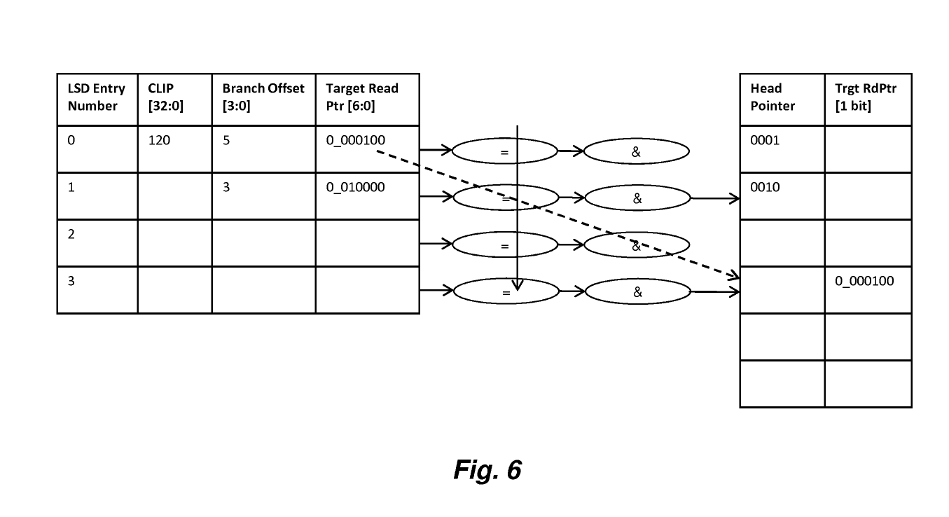

Another embodiment of the PFB LSD is shown in FIG. 6 where the number of entries for the LSD fields is smaller than the number of PFB entries to reduce power/area. Specifically, in this example, there are four entries for the LSD fields (having LSD entry numbers 0-3) and six entries for the PFB fields (numbered 0-5). The Head Pointer value in each PFB entry is used to point to the LSD entry associated with branch instructions that are predicted by the predictors in the fetch unit. For example, head pointer 0001 points to LSD entry number 0; head pointer 0010 points to LSD entry number 1; head pointer 0100 points to LSD entry number 2; and head pointer 1000 points to LSD entry number 3. The head pointer value of 0000 indicates that the PFB entry does not have a BTB predicted branch that points to an LSD entry. Thus, a match is detected in the prefetch buffer if (1) a matching CLIP and branch offset is detected and (2) the matching LSD entry has a corresponding valid head pointer pointing to it from any of the PFB entries. In one embodiment, bit[0] of the head pointer from the PFB entries is OR'ed and qualified with the match. (3) In one embodiment, if there is a match against one of the entries in the LSD structure of the PFB, the PFB Target Read Ptr field of the matching entry is copied into the entry of the PFB to which the corresponding cache line with the BTB prediction is being written. In addition, the LSD Valid bit is set for the PFB entry that is being currently written that has the BTB predicted branch instruction. (4) When the PFB read pointer reaches an entry that has the LSD valid bit set, it is used to read all the information from the entry including the PFB target read pointer and the LSD Valid bit. (5) Based on the LSD valid bit, instead of reading the next sequential PFB entry it is redirected to the entry using the target read pointer. (6) The PFB entries are then read sequentially until the entry with the PFB valid bit is read and the PFB uses the Target Read Pointer to read the next PFB entry. (7) The above operations 5 and 6 are then repeated.

In one embodiment of the invention, the processor in which the embodiments of the invention are implemented comprises a low power processor such as the Atom™ processor designed by Intel™ Corporation. However, the underlying principles of the invention are not limited to any particular processor architecture. For example, the underlying principles of the invention may be implemented on various different processor architectures including the Core i3, i5, and/or i7 processors designed by Intel or on various low power System-on-a-Chip (SoC) architectures used in smartphones and/or other portable computing devices.

FIG. 8 illustrates an exemplary computer system 800 upon which embodiments of the invention may be implemented. The computer system 800 comprises a system bus 820 for communicating information, and a processor 810 coupled to bus 820 for processing information. Computer system 800 further comprises a random access memory (RAM) or other dynamic storage device 825 (referred to herein as main memory), coupled to bus 820 for storing information and instructions to be executed by processor 810. Main memory 825 also may be used for storing temporary variables or other intermediate information during execution of instructions by processor 810. Computer system 800 also may include a read only memory (ROM) and/or other static storage device 826 coupled to bus 820 for storing static information and instructions used by processor 810.

A data storage device 827 such as a magnetic disk or optical disc and its corresponding drive may also be coupled to computer system 800 for storing information and instructions. The computer system 800 can also be coupled to a second I/O bus 850 via an I/O interface 830. A plurality of I/O devices may be coupled to I/O bus 850, including a display device 843, an input device (e.g., an alphanumeric input device 842 and/or a cursor control device 841).

The communication device 240 is used for accessing other computers (servers or clients) via a network, and uploading/downloading various types of data. The communication device 240 may comprise a modem, a network interface card, or other well known interface device, such as those used for coupling to Ethernet, token ring, or other types of networks.

FIG. 9 is a block diagram illustrating another exemplary data processing system which may be used in some embodiments of the invention. For example, the data processing system 900 may be a handheld computer, a personal digital assistant (PDA), a mobile telephone, a portable gaming system, a portable media player, a tablet or a handheld computing device which may include a mobile telephone, a media player, and/or a gaming system. As another example, the data processing system 900 may be a network computer or an embedded processing device within another device.

According to one embodiment of the invention, the exemplary architecture of the data processing system 900 may used for the mobile devices described above. The data processing system 900 includes the processing system 920, which may include one or more microprocessors and/or a system on an integrated circuit. The processing system 920 is coupled with a memory 910, a power supply 925 (which includes one or more batteries) an audio input/output 940, a display controller and display device 960, optional input/output 950, input device(s) 970, and wireless transceiver(s) 930. It will be appreciated that additional components, not shown in FIG. 9, may also be a part of the data processing system 900 in certain embodiments of the invention, and in certain embodiments of the invention fewer components than shown in FIG. 9 may be used. In addition, it will be appreciated that one or more buses, not shown in FIG. 9, may be used to interconnect the various components as is well known in the art.

The memory 910 may store data and/or programs for execution by the data processing system 900. The audio input/output 940 may include a microphone and/or a speaker to, for example, play music and/or provide telephony functionality through the speaker and microphone. The display controller and display device 960 may include a graphical user interface (GUI). The wireless (e.g., RF) transceivers 930 (e.g., a WiFi transceiver, an infrared transceiver, a Bluetooth transceiver, a wireless cellular telephony transceiver, etc.) may be used to communicate with other data processing systems. The one or more input devices 970 allow a user to provide input to the system. These input devices may be a keypad, keyboard, touch panel, multi touch panel, etc. The optional other input/output 950 may be a connector for a dock.

Other embodiments of the invention may be implemented on cellular phones and pagers (e.g., in which the software is embedded in a microchip), handheld computing devices (e.g., personal digital assistants, smartphones), and/or touch-tone telephones. It should be noted, however, that the underlying principles of the invention are not limited to any particular type of communication device or communication medium.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A method for reducing power consumption on a processor having an instruction fetch unit and a prefetch buffer comprising:
detecting a branch, the branch having addressing information associated therewith;
comparing the addressing information with entries in an instruction prefetch buffer to determine whether an executable instruction loop exists within the prefetch buffer;
wherein if an instruction loop is detected as a result of the comparison, then powering down an instruction fetch unit and/or components thereof; and
streaming instructions directly from the prefetch buffer until a clearing condition is detected.

2. The method as in claim 1 wherein the addressing information comprises a current linear instruction pointer (CLIP), a branch offset, and/or a branch target address.

3. The method as in claim 1 wherein the clearing condition comprises a mis-predicted branch.

4. The method as in claim 1 wherein the instruction loop comprises a nested instruction loop.

5. The method as in claim 1 wherein powering down the instruction fetch unit comprises powering down an instruction cache and/or an instruction decode cache.

6. The method as in claim 5 wherein powering down the instruction fetch unit comprises powering down a branch prediction unit, next instruction pointer, and/or an instruction translation lookaside buffer (ITLB).

7. The method as in claim 1 wherein streaming instructions comprises reading the instructions from the instruction prefetch buffer and providing the instructions to a decode stage of a processor pipeline.

8. An apparatus for reducing power consumption on a processor comprising:
an instruction fetch unit predicting a branch, the branch having addressing information associated therewith;
a loop stream detector unit comparing the addressing information with entries in an instruction prefetch buffer to determine whether an executable instruction loop exists within the prefetch buffer;
wherein if an instruction loop is detected as a result of the comparison, then powering down an instruction fetch unit and/or components thereof; and
streaming instructions directly from the prefetch buffer until a clearing condition is detected.

9. The apparatus as in claim 8 wherein the addressing information comprises a current linear instruction pointer (CLIP), a branch offset, and/or a branch target address.

10. The apparatus as in claim 8 wherein the clearing condition comprises a mis-predicted branch.

11. The apparatus as in claim 8 wherein the instruction loop comprises a nested instruction loop.

12. The apparatus as in claim 8 wherein powering down the instruction fetch unit comprises powering down an instruction cache and/or an instruction decode cache.

13. The apparatus as in claim 12 wherein powering down the instruction fetch unit comprises powering down a branch prediction unit, next instruction pointer, and/or an instruction translation lookaside buffer (ITLB).

14. The apparatus as in claim 8 wherein streaming instructions comprises reading the instructions from the instruction prefetch buffer and providing the instructions to a decode stage of a processor pipeline.

15. A computer system comprising:
a display device;
a memory for storing instructions;
a processor for processing the instructions comprising:
an instruction fetch unit predicting a branch, the branch having addressing information associated therewith;
a loop stream detector unit comparing the addressing information with entries in an instruction prefetch buffer to determine whether an executable instruction loop exists within the prefetch buffer;
wherein if an instruction loop is detected as a result of the comparison, then powering down an instruction fetch unit and/or components thereof; and
streaming instructions directly from the prefetch buffer until a clearing condition is detected.

16. The system as in claim 15 wherein the addressing information comprises a current linear instruction pointer (CLIP), a branch offset, and/or a branch target address.

17. The system as in claim 15 wherein the clearing condition comprises a mis-predicted branch.

18. The system as in claim 15 wherein the instruction loop comprises a nested instruction loop.

19. The system as in claim 15 wherein powering down the instruction fetch unit comprises powering down an instruction cache and/or an instruction decode cache.

20. The system as in claim 19 wherein powering down the instruction fetch unit comprises powering down a branch prediction unit, next instruction pointer, and/or an instruction translation lookaside buffer (ITLB).

21. The system as in claim 15 wherein streaming instructions comprises reading the instructions from the instruction prefetch buffer and providing the instructions to a decode stage of a processor pipeline.
